(19) United States
(12) Patent Application Publication
(10) Pub. No.: US 2025/0245561 A1
(43) Pub. Date: Jul. 31, 2025

(54) MACHINE LEARNING FOR TABULAR DATA

(71) Applicant: Fujitsu Limited, Kawasaki-shi (JP)

(72) Inventors: Maria XENOCHRISTOU, San Francisco, CA (US); Wei-Peng CHEN, Fremont, CA (US)

(73) Assignee: Fujitsu Limited, Kawasaki-shi (JP)

(21) Appl. No.: 18/429,282

(22) Filed: Jan. 31, 2024

(51) Int. Cl. G06N 20/00; G06T 11/00

(52) U.S. Cl. CPC G06N 20/00; G06T 11/001

(57) ABSTRACT

According to an aspect of at least one embodiment, one or more operations may include accessing a dataset including multiple data subsets. Each of the data subsets may include multiple tabular data values. A set of images may be generated from a data subset of the multiple data subsets. Each image of the set of images may be generated using a different configuration of an image generation process. A composite image may be formed using the set of images. The composite image may be input to a machine learning model to obtain a prediction for a value in the data subset. The machine learning model may be trained based on the prediction.

### FIELD

The present disclosure generally relates to machine learning for tabular data.

### BACKGROUND

Machine learning (ML) approaches may identify and learn from patterns in training data to recognize patterns in new data to provide insights and predictions corresponding to that new data. In some circumstances, the data used may be tabular datasets. The accuracy of machine learning trained on tabular datasets may be affected by various aspects of tabular datasets. For example, tabular data may demonstrate high levels of heterogeneity of data feature types while other tabular datasets may be sparse in availability or quality of data or may be highly specific (rendering learning difficult to translate from one dataset to another). Additionally, the absence of a hierarchical structure in tabular data can render the extraction of patterns and correlations more challenging for deep learning methods.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of at least one embodiment, one or more operations may include accessing a dataset including multiple data subsets. Each of the data subsets may include multiple tabular data values. A set of images may be generated from a data subset of the multiple data subsets. Each image of the set of images may be generated using a different configuration of an image generation process. A composite image may be formed using the set of images. The composite image may be input to a machine learning model to obtain a prediction for a value in the data subset. The machine learning model may be trained based on the prediction.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example environment to train a machine learning model;

FIG. 2 illustrates an example process configured to perform data transformation;

FIG. 3 illustrates an example process configured to determine a loss metric;

FIG. 4 is a flowchart of a method of training a machine learning model; and

FIG. 5 illustrates an example computing system, all in accordance with one or more embodiments of the present disclosure.

### DETAILED DESCRIPTION

Machine learning models may be trained using a training dataset to make predictions. The training dataset may include training instances or individual data points used to train the ML model. Individual data points may correspond to features and a target variable that the ML model may be designed to predict. The features may define the characteristics of the data that the ML model may use to make predictions. For example, the ML model may generate a prediction from the data depending on different characteristics of the data, which may be identified as patterns in the data.

In some instances, a dataset may be represented in different formats. For instance, the dataset may be represented in a tabular format having multiple columns and rows. In such instances, the rows may represent individual observations and the columns may correspond to certain features having different feature types that each of the observations may include.

In some circumstances, machine learning models may be trained to predict a value of a feature given values of the other features for a single observation. However, in some circumstances, training a machine learning model using tabular data in a tabular data format may be difficult due to various characteristics of tabular data.

According to one or more embodiments of the present disclosure, the tabular data may be transformed into images and the images may be used to train a ML model. Transforming the tabular data into images may allow for more robust training of the ML model and allow the ML model to make better predictions on future data similar to the tabular data. Alternately or additionally, transforming the tabular data into images may facilitate the use of techniques such as self-supervised and semi-supervised learning, transfer learning, and data augmentation.

In some embodiments, a subset of a dataset may be transformed into images and used to train a ML model. For example, the subset of the dataset may be transformed into multiple images for processing by the ML model. In these and other embodiments, the subsets of the dataset may be a single row of the dataset. The data from the single row may be used to generate different sets of images. For example, an image generation process may be applied to the data points in the row to generate a first set of images. A configuration of the image generation process may be varied so that the first set of images may be generated with each image different from the others of the first set. A second set of images may be generated in a similar manner by changing the configuration of the image generation process so that each image in the second set of images is different from the others.

For example, the first set of images may be generated using an image generation process where a distance metric and a perplexity of the image generation process may be adjusted. In these and other embodiments, a cosine distance metric may be used for the entire first set and a variable perplexity may be used for each image of the first set. In generating the second set of images, a Euclidian distance function may be used for the entire second set and a variable perplexity may be used for each image of the second set.

In some embodiments, the first set of images may be combined to form a first composite image and the second set of images may be combined to form a second composite image. The first composite image may be input into an ML model to obtain a first prediction. The second composite image may be input into the ML Model to obtain a second prediction. One or both of the first prediction and the second prediction may be used to determine how to adjust the parameters of the ML model to train the ML model based on the dataset. In some embodiments, the first prediction is compared against a labeled dataset to determine a difference, referred to in this disclosure as a supervised loss value. Alternately, or additionally, a comparison of the first prediction and the second prediction may be used to determine a difference, referred to in this disclosure as a consistency loss value. In some embodiments, the supervised loss value and the consistency loss value may be combined to generate a total loss value. The ML model may be updated based on one or more of the supervised loss value, the consistency loss value, or the total loss value.

Embodiments of the present disclosure are explained with reference to the accompanying figures.

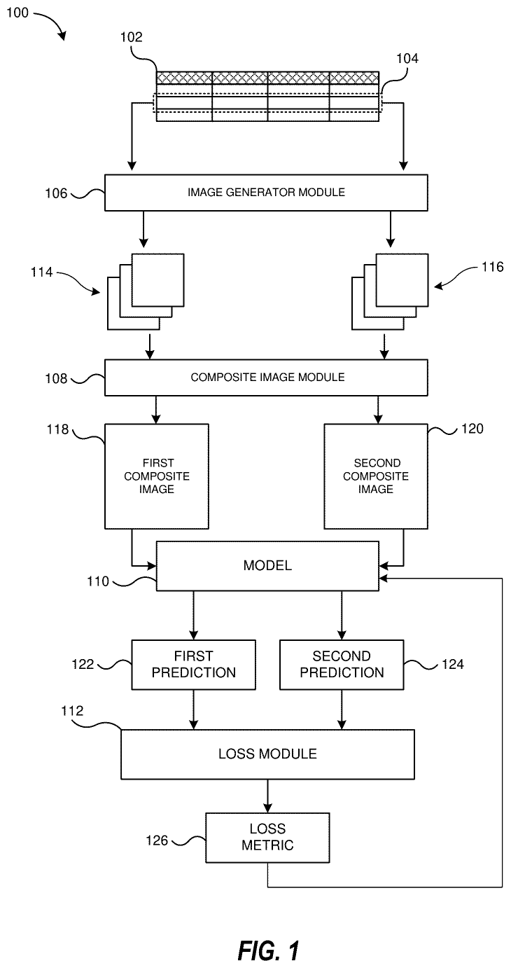

FIG. 1 illustrates an example environment 100 configured for machine learning training, in accordance with one or more embodiments of the present disclosure. In general, the environment 100 may be configured to train and/or generate a model 110, such as a ML model. In some embodiments, the environment 100 may be configured to train the model 110 using a dataset 102 to improve the model 110.

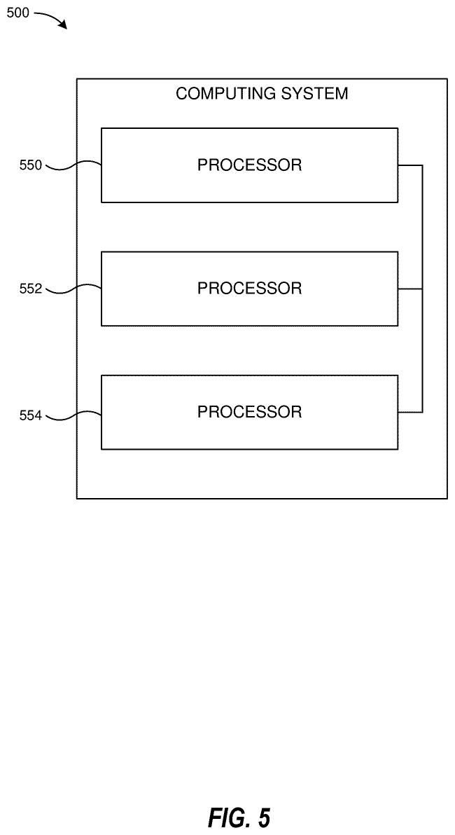

In some embodiments, the environment 100 may include an image generator module 106, a composite image module 108, and a loss analysis module 112, which may be generally referred to as “the modules.” In some embodiments, one or more of the modules may include code and routines configured to allow a computing system to perform one or more operations. Additionally or alternatively, one or more of the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the modules may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as that described in further detail with respect to FIG. 5.

In some embodiments, the dataset 102 may be a training dataset that may be used to train the model 110. The dataset 102 may be obtained from any source or constructed using any data compilation technique. The data may include numerical data, character strings that include characters, such as letters, symbols, or other characters, numbers, or a combination of numbers, symbols, and/or characters. The data may also include other data formats. In these and other embodiments, the data may be processed before the machine learning training. For example, non-numeric data may be converted to numeric data. Alternately or additionally, the data may be scaled. For example, the data may be scaled to have a mean of zero and a variance of one.

In some embodiments, the data in the dataset 102 may be organized into one or more data subsets 104. For example, data points corresponding to the same observation, such as an event, item, etc. may be organized into the same data subset 104 (e.g., row in tabular data) with each data subset having data points in different categories corresponding to the observation. For instance, an example of the dataset 102 may be real estate data that includes addresses, lot values, lot sizes, and lot improvements. As an example, the data representing a particular lot may form at least part of a data subset 104.

As an example, the dataset 102 may include tabular data that may be arranged in columns and rows. In these and other embodiments, each of the rows may represent a data subset 104 of the dataset 102 and each of the columns may correspond to a feature of the data subset 104. The values in one of the rows may be associated together. For example, following the previous example, the values for each of the columns in a single row may be associated with the same lot.

In some embodiments, the image generator module 106 may be configured to generate a first set of images 114 and a second set of images 116 for each data subset 104. In other words, for a single data subset (e.g., row), a first set of images 114 is generated and a second set of images 116 is generated. Each set of images may include multiple images and each of the multiple images may be generated using the same data from the data subset 104. For each image generated, a configuration of the image generation process may be adjusted so that each image of each set of the images is different even though the data used to generate each image is the same. For example, if two sets of images are generated and each set of images includes three images then six different images may be generated.

In some embodiments, the image generation process performed by the image generator module 106 may be configured to reduce the dimensionality of the data subset 104. For example, each data point in the data subset 104 may be considered a different dimension, such that the data subset 104 is a high-dimensional space. The image generation process may be configured to project the data points to a two-dimensional plot in a manner so that data points that are close in the initial high-dimensional space remain close in the resulting projection and data points that are far from each other remain far from each other in the low-dimensional space.

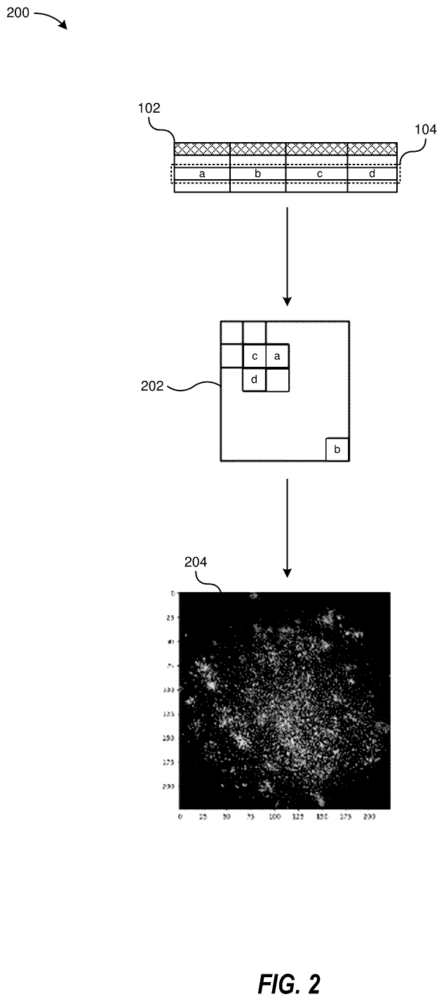

An example of the image generation process is shown in FIG. 2. In some embodiments, the image generation may create a probability distribution that captures distance relationships between the data points in the data subset 104. The distance relationship may be determined using one of many types of distances measure techniques or metrics. For example, the distance between two data points may be determined using cosine, Euclidean, Manhattan, Chebyshev, among other types of distance measurement techniques or metrics. Based on the distance relationship between the data points, the image generation process may place the data points into a matrix 202 based on measured distance therebetween. Data points with smaller measured distanced therebetween may be clustered together within the matrix 202. For example, values a, c, and d may be similar, resulting in relatively proximal placement, while value b has a low degree of similarity, resulting in a more distal relative placement within the matrix 202. The resulting two-dimensional matrix 202 is representative of the data of the data subset 104.

The matrix 202 may be used to create an image 204. For example, the matrix locations may be mapped to different pixel locations within the image 204. The values in the matrix locations may be used to determine an intensity value at the pixel. The intensity value may indicate a brightness of the pixel in the image 204. In some embodiments, overlapping data may be averaged or otherwise processed for clarity and accuracy. The resultant image 204 of the first set of images 114 may be similar to a scatter plot or may take another form.

In addition to using distances measure techniques or metrics, a perplexity of the image generation process may also be adjusted. The perplexity may provide guidance to the image generation process regarding a number of close neighbors that each of the data points in the data subset 104 may have. The number of close neighbors may affect how the image generation process balances global and local relationships of the data subset 104. As a result, a change in the perplexity value during the image generation process may result in a change in the output image even when the same data is used during the image generation process. Similarly, a change in the distance measure metric may result in a change in the output image even when the same data is used during the image generation process. Other parameters of the image generation process may also be adjusted or varied for each image generation to generate the different images in the different image sets.

In some embodiments, the image generation process may be a dimensionality reduction processes, such as a t-distributed stochastic neighbor embedding (t-SNE) or kernel principal component analysis (PCA). Other image generation processes may be used as well. When other image generation processes are used, different configurations of the image generation processes that varies the results generated by the image generation processes may be used. For example, the perplexity and distance measure techniques may be used for t-SNE or other similar image generation techniques. Other image generation techniques may adjust other parameters to vary the results.

Returning to FIG. 1, in some embodiments, each image of the first set of images 114 is generated, by the image generator module 106, using a different configuration of the image generation process. In these and other embodiments, a different configuration of the image generation process may result from using one or more different parameters during the image generation process. In these and other embodiments, the differences between the images of the first set of images 114 may be due to a change in a configuration of the image generation process which may result from a change in one or more parameters of the image generation process. For example, for the entire first set of images 114, a constant distance metric may be selected (e.g., cosine, Euclidean, Manhattan, etc.) while the perplexity value may be varied for each of the images in the first set of images 114. As an example, the first image of the first set of images 114 may be generated using a cosine distance metric and a perplexity value of 5, the second image generated using the cosine distance metric and a perplexity of 20, and the third image generated using the cosine distance metric and a perplexity value of 35. As another example, the perplexity may be held constant across the first set of images 114 while the distance metric may be changed for each image in the set of images.

The second set of images 116 may be generated using the image generation process. The second set of images 116 may be generated such that the second set of images 116 are different from each other and from the first set of images 114. The second set of images 116 may be generated to be different in a similar manner as explained above with respect to the first set of images 114. In some embodiments, some of the parameters used to generate the first set of images 114 may be the same as the parameters used to generate the second set of images 116. For example, the values of the perplexity used to generate the first set of images 114 may be the same values used to generate the second set of images 116, but a different distance metric may be used to generate the second set of images 116 than is used to generate the first set of images 114. Alternately, or additionally, each of the parameters used to generate the second set of images 116 may be different than the parameters used to generate the first set of images 114.

While, in the illustrated embodiment, three different images are generated to form each of the first set of images 114 and the second set of images 116, fewer or more than three images may be generated for each set of images. Alternately or additionally, any number of set of images may be generated. For example, one set of images may be generated as described later in this disclosure. Alternately or additionally, three, four, five, or more sets of images may be generated. Each set of images may be generated using different configurations of the image generation process.

In some embodiments, each of the generated images in the first and second sets of images 114 and 116 may be generated with a different color channel of a color model. In this and other examples, the first set of images 114 may be generated in accordance with a RGB color model that includes three different color channels. In this example, the first set of images 114 may include three images. The pixels of each of the images may each be one of the color channels red, green, and blue. For example, each pixel of a first image may be blue channel, each pixel of a second image may be red channel, and each pixel of a third image may be green channel. As another example, the color model may be the CMYK color model or some other color model. In some embodiments, the images may be randomly organized into color channels. Thus, the first image generated may randomly assigned one channel of the possible color channels.

In some embodiments, the first set of images 114 are input to the composite image module 108. The composite image module 108 may be configured to combine the first set of images 114 into a first composite image 118. The composite image 118 may be a combination of each of the images from the first set of images 114. In these and other embodiments, the composite image 118 may include all the colors.

The second set of images 116 may also be combined by the composite image module 108 to form a second composite image 120. In these and other embodiments, the composite image 120 may include all the colors.

One or both the first composite image 118 and the second composite image 120 may be input to the model 110. In some embodiments, the model 110 is a neural network, such as a transformer or other machine learning model. For example, the model 110 may include a reference vision transformer such as a data-efficient image transformer (DeiT). The model 110 may be an image classification or regression model based on a vision transformer (ViT). The model 110 may be configured to directly process image data (e.g., the first and second composite images 118, 120). In some embodiments, the model 110 may be pre-trained on an image dataset.

Each of the first composite image 118 and the second composite image 120 may provide different augmented versions of the same data subset 104. In some embodiments, the model 110 may use an encoder (e.g., data-efficient image transformer) on each of the first composite image 118 and the second composite image 120 to extract features from the images. The extracted features may be processed through one or more linear layers. The linear layers may provide a linear transformation and final output of the model. The model 110 may be configured to process the first composite image 118 through the same or separate linear layer from a linear layer used to process the second composite image 120.

In some embodiments, the model 110 may benefit from the composite nature of the first and second composite images 118, 120. For example, feature extraction may be performed on each of the composite images 118, 120. Feature extraction on the composite images 118, 120 may allow for additional learning based on differences and similarities in the different portions of each of the composite images 118, 120 corresponding to the respective sets of images 114, 116. With this additional feature learning available to the model 110, high-dimensional feature relationships and patterns may be identified in a lower-dimensional representation. This perspective and insight may allow the model 110 to identify patterns and relationships (global and local) in the data subset 104 for prediction generation.

The model 110 may generate a first prediction 122 corresponding to the first composite image 118 and a second prediction 124 corresponding to the second composite image 120. The first prediction 122 may include a predicted value for a feature of the data subset 104 given the values of the other features of the data subset 104. Thus, the predicted value may not be provided to the model 110, but the model 110 may predict or determine the value given the values of the other features of the data subset 104. The second prediction 124 may also include a predicted value for the feature. The second prediction 124 may vary from the first prediction 122 given the changes in the configuration of the image generation process used in generating the sets of images that results in the first and second predictions 122, 124. For example, when the data subset 104 includes information regarding a lot, such as a plot of land, the first prediction 122 may include a value for a feature of the lot given the other information regarding the lot, such as a current or future value of the lot.

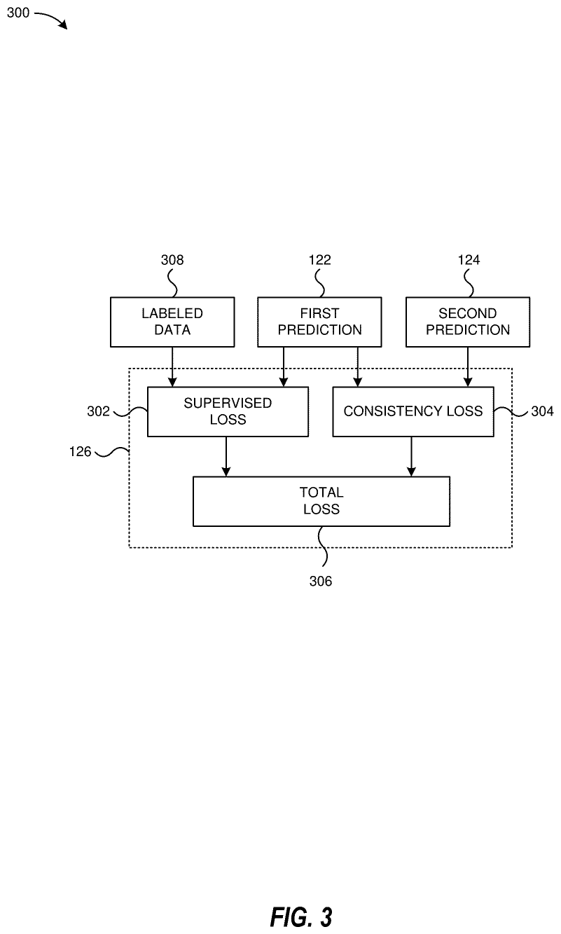

In some embodiments, one or more of the first and second predictions 122, 124 may be provided to the loss module 112 to determine a loss metric 126. In some embodiments, the loss metric 126 may indicate how well the model 110 predicted a value of a feature of the data subset 104 given values of other features of the data subset 104. In these and other embodiments, the loss metric 126 may be based on a difference between the first and second predictions 122, 124 and/or a difference between the one or more of the first and second predictions 122, 124 and labeled data from the data subset 104. Further details regarding the determination of the loss metric are described below with respect to FIG. 3.

In some embodiments, the loss metric 126 may be used to train the model 110. For example, the parameters of the model 110 may be updated to minimize the loss metric 126. For example, the parameters of the model 110 may be updated such that the model 110 in a future operation given the same inputs may generate the first and second predictions 122, 124 to be more similar and/or for one of the first and second predictions 122, 124 to be more a more accurate prediction of a feature of the data subset 104 for which the model 110 is being trained to predict. Training the model 110, based on the loss metric 126, may be performed using backpropagation, an optimizer, and/or other approaches.

In some embodiments, an additional self-supervised pre-training step may be included in which the model 110 is pre-trained using a contrastive loss based on at least one of the first set of images 114 or the second set of images 116. An encoder (neural network or the like) may be integrated to reduce a dimensionality characteristic of the image sets 114, 116. For example, each of the images in the first set of images 114 may be transformed to form a set of embeddings. In some cases, the sets of images including sets of embeddings may allow the model 110 to learn about data relationships without explicit labels. A projector may be incorporated to process the embeddings and output one or more projections in a manner facilitating a contrastive loss determination on the projections. A contrastive loss determination may allow the model 110 to distinguish between images that originated from different samples in the dataset 102 based on the concept that embeddings from the same sample are expected to have a higher degree of similarity in the projections than embeddings from different samples.

In other embodiments, a supervised training process may be incorporated in addition to, or in place of, the method illustrated and described with respect to FIGS. 1 and 3. For example, a shared encoder (e.g., DeiT, CNN, or the like) of model 110 may be used to process the first composite image 118 and the second composite image 120 and distill one or more features from each composite image 118, 120. Dimensionality of the composite images 118, 120 may be reduced to generate embeddings. The embeddings may be concatenated to combine features from both the first composite image 118 and the second composite image 120 into a unified representation. The concatenated embeddings may be subjected to dimensionality reduction through a linear layer of the model 110 to refine the feature set for classification. A supervised loss determination may be applied to quantify a difference between a prediction of the model 110 and an actual label associated with the data provided to the model 110 to generate the prediction. The supervised loss may be used to update at least one parameter of the model 110 to increase the ability of the model 110 to predict a label associated with each image.

While the environment 100 is shown and described in a model training format, other embodiments may implement the model 110 in a non-training predictive format. For example, in a non-training predictive format, the environment 100 may intake the data subset 104 and generate, via the image generator module 106, the first set of images 114. The first set of images 114 may be used to generate the first composite image 118. The model 110 (e.g., trained) may analyze the first composite image 118 to generate the first prediction 122. The first prediction 122 may correspond to requested data based on the data subset 104. For example, the first prediction 122 may predict a value of the requested data given the other values of the data subset 104. For example, given information about a lot, the first prediction 122 may predict a present or future value of the lot.

FIG. 3 illustrates an example process 300 configured to determine a loss metric 126. In some embodiments, the process 300 may include calculation of a supervised loss 302 and a consistency loss 304 to determine a total loss 306. In some embodiments, the supervised loss 302 may be determined by comparing one or both of the first prediction 122 and the second prediction 124 to labeled data 308. The labeled data 308 may be part of a training dataset used during training of the model 110. For example, the data subset 104 may include values for each feature in the data subset 104. One or more of the values of the data subset 104 besides the values of the labeled data 308 may be used to generate the sets of images and thereby provided to the model 110. The model 110 may be configured to predict the value of the labeled data 308 given the one or more values of the data subset 104 provided to the model 110. The first prediction 122 and the second prediction 124 may be predictions of the value of the labeled data 308. Comparing the first prediction 122 or the second prediction 124 with the labeled data 308 provides the supervised loss 302. The supervised loss 302 may provide an indication of how well the model 110 may be able to predict the labeled data 308 given data associated with the labeled data 308.

In some embodiments, the consistency loss 304 may be determined by a direct comparison of the first prediction 122 and the second prediction 124. The consistency loss 304 may present a difference between the first prediction 122 and the second prediction 124. This comparison provides insight into how consistent the model 110 is at providing predictions with different augmentations of the same data subset 104. For example, a lower consistency loss 304, indicating that the difference between the first prediction 122 and the second prediction 124 is small, may indicate that the model 110 is more robust and may generate better predictions for data values that are not found in the dataset 102 used for training the model 110.

In some embodiments, calculation of the total loss 306 may be based on the supervised loss 302 and the consistency loss 304. For example, the supervised loss 302 and the consistency loss 304 may be combined to generate the total loss 306. In these and other embodiments, various weights, averages, or other mathematical manipulations may be used in combining the supervised loss 302 and the consistency loss 304 in determining the total loss 306. Calculation of the loss metric 126 using the total loss 306 that is based on the supervised loss 302 and the consistency loss 304 may help the model 110 to learn from relatively limited datasets and may reduce overfitting through early stopping during training of the model 110.

Note that in some embodiments, the method of training the model 110 may not include determination of the consistency loss 304. In these and other embodiments, the second set of images 116, the second composite image 120, and the second prediction 124 may not be generated. In these and other embodiments, the total loss 306 may be based on the supervised loss 302 and the parameters of the model 110 may be updated based on the supervised loss without calculation of the consistency loss 304.

As another example, during training of the model 110, the supervised loss may be calculated for each data subset 104 used to train the model 110. In these and other embodiments, a consistency loss may be calculated for a portion of the data subsets 104 used to train the model 110 and used for training of the model 110.

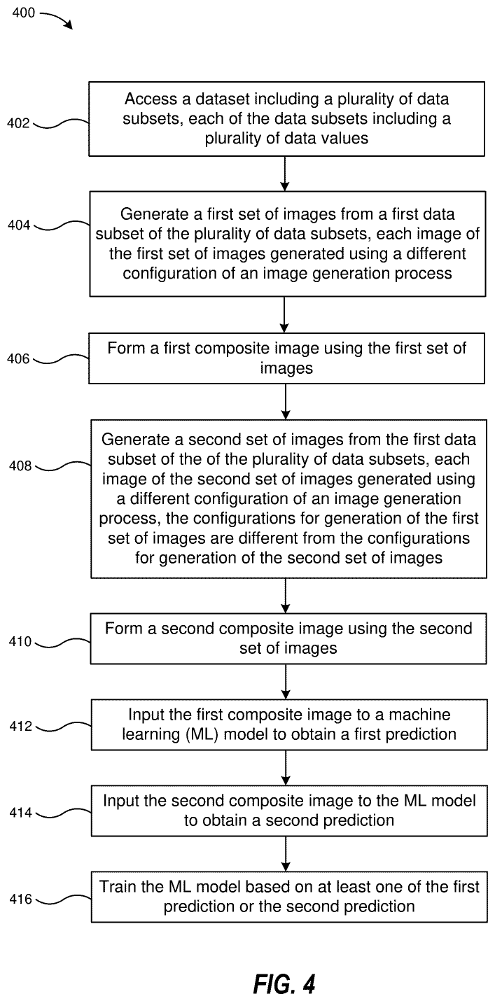

FIG. 4 illustrates a flowchart of an example method 400 of training a machine learning model, in accordance with one or more embodiments of the present disclosure. The method 400 may be performed by any suitable system, apparatus, or device. For example, the method 400 may be implemented using the environment 100 of FIG. 1 or the computing system 500 of FIG. 5. Although illustrated with discrete blocks, the steps and operations associated with one or more blocks of the method 400 may be divided into additional blocks, combined into fewer blocks, or eliminated, depending on the particular implementation. For example, one or more of the operations described above with respect to the process 200 of FIG. 2 may be performed as part of the method 400.

The method 400 may include block 402. At block 402 a dataset that includes multiple data subsets, each including multiple data values may be accessed. The feature types corresponding to the data subsets may not yet have been identified. The dataset 102 and data subset 104 described with respect to FIGS. 1 and 2, respectively, may be examples of the accessed dataset and data subset. In some embodiments, the dataset may be a tabular dataset.

At block 404, a first set of images may be generated. The first set of images may be generated from a first data subset of the multiple data subsets. Each image of the first set of images may be generated using a different configuration of an image generation process, as described with respect to the image generator module 106 of FIG. 1. Examples of the process may include using a constant distance metric throughout the set of images and a different perplexity value for each image or using a constant perplexity value throughout the set of images with a different distance metric for each image of the set of images.

At block 406, a first composite image may be formed. In some embodiments, the first composite image may be the first composite image 118 of FIG. 1 generated by the composite image module 108 of FIG. 1.

At block 408, a second set of images may be generated. The second set of images may be generated from the first data subset of the multiple data subsets. Each image of the second set of images may be generated using a different configuration of an image generation process. In some embodiments, the configurations used to generate the images of the second set of images may be different than the configuration used to generate the images of the first set of images. For example, the second set of images may be generated using a distance metric different from a distance metric used to generate the first set of images but the different values of perplexity variable may be identical when generating both sets of images. In these and other embodiments, the different configurations of the image generation process may be selected by a user. Additionally, or alternatively, the different configurations of the image generation process may be populated automatically based on one or more characteristics of the data and/or data subset.

At block 410, a second composite image may be formed using the second set of images. In some embodiments, the second composite image may be the second composite image 120 of FIG. 1 generated by the composite image module 108 of FIG. 1.

At block 412, a first composite image may be input into an ML model to obtain a first prediction. In some embodiments, the ML model may be the model 110 of FIG. 1 and the first prediction may be the first prediction 122 of FIG. 1.

At block 414, a second composite image may be input into the ML model to obtain a second prediction. In some embodiments, the second prediction may be the second prediction 124 of FIG. 1. Generation of the first prediction and the second prediction may be run in parallel or sequentially.

At block 416, the ML model may be trained based on at least one of the first prediction or the second prediction. In some embodiments, at least one of the first prediction or the second prediction may be used to generate a supervised, semi-supervised, consistency, contrastive, or other loss metric or total loss metric.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

For example, the method 400 may further include training the ML model which may include updating at least one parameter of the model based on a difference between the first prediction and the value of the first data subset where the first prediction includes a prediction for a value in the first data subset.

As another example, the method 400 may further include updating at least one parameter of the model based on a difference between the first prediction and the second prediction. In these and other embodiments, the method 400 may further include obtaining a second difference between the first prediction and the value of the first data subset and combining the difference between the first prediction and the second prediction with the second difference. Alternately or additionally, at least one parameter of the model may be updated based on the combined differences.

FIG. 5 illustrates a block diagram of an example computing system 500, according to at least one embodiment of the present disclosure. The computing system 500 may be configured to implement or direct one or more suitable operations described in the present disclosure. For example, the computing system 500 may be configured to perform one or more blocks of the modules of FIG. 1, the processes of FIG. 2, the processes of FIG. 3, or the method of FIG. 4. Additionally, or alternatively, one or more of the modules of FIG. 1 may be implemented by or include the computing system 500. The computing system 500 may include a processor 550, a memory 552, and a data storage 554. The processor 550, the memory 552, and the data storage 554 may be communicatively coupled.

In general, the processor 550 may include any suitable special-purpose or general-purpose computer, computing entity, or processing device including various computer hardware or software modules and may be configured to execute instructions stored on any applicable computer-readable storage media. For example, the processor 550 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 550 may include any number of processors configured to, individually or collectively, perform or direct performance of any number of operations described in the present disclosure. Additionally, one or more of the processors may be present on one or more different electronic devices, such as different servers.

In some embodiments, the processor 550 may be configured to interpret and/or execute program instructions and/or process data stored in the memory 552, the data storage 554, or the memory 552 and the data storage 554. In some embodiments, the processor 550 may fetch program instructions from the data storage 554 and load the program instructions in the memory 552. After the program instructions are loaded into memory 552, the processor 550 may execute the program instructions.

The memory 552 and the data storage 554 may include computer-readable storage media for carrying or having computer-executable instructions or data structures stored thereon. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007).

Combinations of the above may also be included within the scope of computer-readable storage media. Computer-executable instructions may include, for example, instructions and data configured to cause the processor 550 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
accessing a dataset including a plurality of data subsets, each of the data subsets including a plurality of tabular data values;
generating a first set of images from a first data subset of the plurality of data subsets, each image of the first set of images generated using a different configuration of an image generation process;
forming a first composite image using the first set of images;
generating a second set of images from the first data subset of the plurality of data subsets, each image of the second set of images generated using a different configuration of an image generation process, wherein the configurations for generation of the first set of images are different from the configurations for generation of the second set of images;
forming a second composite image using the second set of images;
inputting the first composite image to a machine learning (ML) model to obtain a first prediction;
inputting the second composite image to the ML model to obtain a second prediction; and
training the ML model based on at least one of the first prediction or the second prediction.

2. The method of claim 1, wherein configurations of the image generation process differ by adjusting one or more of a distance metric and a perplexity value used during the image generation process.

3. The method of claim 1, wherein each image of the first set of images represents a single color of a color model such that the composite image includes all of the colors of the color model.

4. The method of claim 1, wherein the first prediction includes a prediction for a value in the first data subset and training the ML model includes updating at least one parameter of the model based on a difference between the first prediction and the value of the first data subset.

5. The method of claim 1, wherein training the ML model based on at least one of the first prediction or the second prediction includes updating at least one parameter of the model based on a difference between the first prediction and the second prediction.

6. The method of claim 5, wherein the first prediction includes a prediction for a value in the first data subset and training the ML model based on at least one of the first prediction or the second prediction further includes:
obtaining a second difference between the first prediction and the value of the first data subset;
combining the difference between the first prediction and the second prediction with the second difference; and
updating at least one parameter of the model based on the combined differences.

7. The method of claim 1, wherein training the ML model based on at least one of the first prediction or the second prediction further includes updating at least one parameter of the model based on a comparison of the first composite image and the second composite image.

8. One or more non-transitory computer-readable media storing instructions that, in response to being executed by one or more processors, cause a system to perform the method of claim 1.

9. A method comprising:
accessing a dataset including a plurality of data subsets, each of the data subsets including a plurality of tabular data values;
generating a set of images from a data subset of the plurality of data subsets, each image of the set of images generated using a different configuration of an image generation process;
forming a composite image using the set of images;
inputting the composite image to a machine learning (ML) model to obtain a prediction for a value in the data subset; and
training the ML model based on the prediction.

10. The method of claim 9, wherein configurations of the image generation process differ by adjusting one or more of a distance metric and a perplexity value used during the image generation process.

11. The method of claim 9, wherein each image of the set of images represents a single color of a color model such that the composite image includes all of the colors of the color model.

12. The method of claim 9, wherein the prediction includes a prediction for a value in the data subset and training the ML model includes updating at least one parameter of the model based on a difference between the prediction and the value of the data subset.

13. The method of claim 9, further comprising generating a second prediction based on a second composite image combining a second set of images using a variation of the image generation process, wherein the prediction is a first prediction and training the ML model includes updating at least one parameter of the model based on a difference between the first prediction and the second prediction.

14. The method of claim 13, wherein the first prediction includes a prediction for a value in the data subset and training the ML model based on at least one of the first prediction or the second prediction further includes:
obtaining a second difference between the first prediction and the value of the first data subset;
combining the difference between the first prediction and the second prediction with the second difference; and
updating at least one parameter of the model based on the combined differences.

15. A system, comprising:
one or more processors; and
one or more non-transitory computer-readable storage media configured to store instructions that, in response to being executed, cause the system to perform operations, the operations comprising:
accessing a dataset including a plurality of data subsets, each of the data subsets including a plurality of tabular data values;
generating a set of images from a data subset of the plurality of data subsets, each image of the set of images generated using a different configuration of an image generation process;
forming a composite image using the set of images;
inputting the composite image to a machine learning (ML) model to obtain a prediction for a value in the data subset; and
training the ML model based on the prediction.

16. The system of claim 15, wherein configurations of the image generation process differ by adjusting one or more of a distance metric and a perplexity value used during the image generation process.

17. The system of claim 15, wherein each image of the set of images represents a single color of a color model such that the composite image includes all the colors of the color model.

18. The system of claim 15, wherein the prediction includes a prediction for a value in the data subset and training the ML model includes updating at least one parameter of the model based on a difference between the prediction and the value of the data subset.

19. The system of claim 15, further comprising generating a second prediction based on a second composite image combining a second set of images using a variation of the image generation process, wherein the prediction is a first prediction and training the ML model includes updating at least one parameter of the model based on a difference between the first prediction and the second prediction.

20. The system of claim 19, wherein the first prediction includes a prediction for a value in the data subset and training the ML model based on at least one of the first prediction or the second prediction further includes:
obtaining a second difference between the first prediction and the value of the data subset;
combining the difference between the first prediction and the second prediction with the second difference; and
updating at least one parameter of the model based on the combined differences.
